(19) United States
(12) Patent Application Publication
(10) Pub. No.: US 2023/0214569 A1
(43) Pub. Date: Jul. 6, 2023

(54) METHOD AND APPARATUS FOR DEVICE SIMULATION

(71) Applicant: CHANGXIN MEMORY TECHNOLOGIES, INC., Hefei City (CN)

(72) Inventor: SHIH-CHIEH LIN, Hefei (CN)

(21) Appl. No.: 17/825,235

(22) Filed: May 26, 2022

Related U.S. Application Data
(63) Continuation of application No. PCT/CN2022/078551, filed on Mar. 1, 2022.

(30) Foreign Application Priority Data
Jan. 6, 2022 (CN) 202210014158.9

(51) Int. Cl. G06F 30/367; G06F 30/3308; G06F 30/337; G06F 30/392

(52) U.S. Cl. CPC G06F 30/367; G06F 30/3308; G06F 30/337; G06F 30/392

(57) ABSTRACT

A method and apparatus for device simulation are provided. The method includes: establishing a simulation model of a to-be-detected device, where the to-be-detected device includes a first resistor and a parasitic resistor, the parasitic resistor includes a second resistor and a contact resistor, the first resistor is a bulk resistor of the to-be-detected device, the second resistor is a terminal resistor of the to-be-detected device, and the contact resistor is an equivalent resistor of a contact plug on the to-be-detected device; determining temperature coefficients of resistance corresponding to the first resistor, the second resistor, and the contact resistor, and adding the temperature coefficients of resistance to the simulation model; and performing device simulation of Simulation Program with Integrated Circuit Emphasis (SPICE) according to the simulation model.

### CROSS-REFERENCE TO RELATED APPLICATION

This application is a US continuation of International Application No. PCT/CN2022/078551, filed on Mar. 1, 2022, which claims priority to Chinese Patent Application No. 202210014158.9, entitled “METHOD AND APPARATUS FOR DEVICE SIMULATTION” and filed to the China National Intellectual Property Administration on Jan. 6, 2022. The disclosures of International Application No. PCT/CN2022/078551 and the Chinese Patent Application No. 202210014158.9 are hereby incorporated by reference in their entireties.

### BACKGROUND

In the semiconductor industry, a modeling simulation technology is often used to extract parameters of components in a semiconductor integrated circuit, simulate the electrical properties of the components, and provide a corresponding process model for subsequent circuit simulation. For example, since a resistor is one of the most basic components in the semiconductor integrated circuit, in the modeling simulation technology, a resistor simulation model is generally established in a Simulation Program with Integrated Circuit Emphasis (SPICE) for simulating the electrical properties of the resistor in various environment parameters, including changes of a resistance value in temperature, size, and operating voltage.

### SUMMARY

Embodiments of the disclosure relate to the technical field of semiconductors, and in particular, to a method and apparatus for device simulation.

Embodiments of the disclosure provide a method and apparatus for device simulation, to enhance the simulation accuracy of a device.

In some embodiments, a method for device simulation is provided and includes the following operations.

A simulation model of a to-be-detected device is established. The to-be-detected device includes a first resistor and a parasitic resistor. The parasitic resistor includes a second resistor and a contact resistor. The first resistor is a bulk resistor of the to-be-detected device. The second resistor is a terminal resistor of the to-be-detected device. The contact resistor is an equivalent resistor of a contact plug on the to-be-detected device.

Temperature coefficients of resistance corresponding to the first resistor, the second resistor, and the contact resistor are determined, and the temperature coefficients of resistance corresponding to the first resistor, the second resistor, and the contact resistor are added to the simulation model.

Device simulation by using SPICE is performed according to the simulation model.

In some embodiments, an apparatus for device simulation is provided, and includes a processing module, a calculation module, and a simulation module.

The processing module is configured to establish a simulation model of a to-be-detected device. The to-be-detected device includes a first resistor and a parasitic resistor. The parasitic resistor includes a second resistor and a contact resistor. The first resistor is a bulk resistor of the to-be-detected device. The second resistor is a terminal resistor of the to-be-detected device. The contact resistor is an equivalent resistor of a contact plug on the to-be-detected device.

The calculation module is configured to determine temperature coefficients of resistance corresponding to the first resistor, the second resistor, and the contact resistor, and add the temperature coefficients of resistance corresponding to the first resistor, the second resistor, and the contact resistor to the simulation model.

The simulation module is configured to perform device simulation by using SPICE according to the simulation model.

In some embodiments, an electronic device is provided and includes at least one processor and a memory.

The memory stores computer-executable instructions.

The at least one processor executes the computer-executable instructions stored in the memory, to cause the at least one processor to execute the method for device simulation provided in the above embodiments.

In some embodiments, a computer-readable storage medium is provided and stores computer-executable instructions. When a processor executes the computer-executable instructions, the method for device simulation provided in the above embodiments is implemented.

### BRIEF DESCRIPTTION OF THE DRAWINGS

FIG. 1 is a schematic diagram I of a longitudinal section of a to-be-detected device according to an embodiment of the disclosure.

FIG. 2 is a schematic layout diagram I of a to-be-detected device according to an embodiment of the disclosure.

FIG. 3 is a schematic flowchart of a method for device simulation according to an embodiment of the disclosure.

FIG. 4 is a schematic diagram II of a longitudinal section of a to-be-detected device according to an embodiment of the disclosure.

FIG. 5 is a schematic diagram of an equivalent resistor of a to-be-detected device according to an embodiment of the disclosure.

FIG. 6 is a schematic layout diagram II of a to-be-detected device according to an embodiment of the disclosure.

FIG. 7 is a schematic sub-flowchart of a method for device simulation according to an embodiment of the disclosure.

FIG. 8 is a schematic diagram of a function curve of a resistance value of the to-be-detected device and a first length according to an embodiment of the disclosure.

FIG. 9 is a schematic diagram of a function curve of a resistance value of the to-be-detected device and a first length at different sampling temperatures according to an embodiment of the disclosure.

FIG. 10 is a schematic length diagram I of a contact terminal of a to-be-detected device on a layout according to an embodiment of the disclosure.

FIG. 11 is a schematic length diagram II of a contact terminal of a to-be-detected device on a layout according to an embodiment of the disclosure.

FIG. 12 is a schematic diagram of a function curve between a temperature coefficient of resistance of a first resistor and an ambient temperature according to an embodiment of the disclosure.

FIG. 13 is a schematic diagram of a function curve between a temperature coefficient of resistance of a contact resistor and an ambient temperature according to an embodiment of the disclosure.

FIG. 14 is a schematic diagram of a program module of an apparatus for device simulation according to an embodiment of the disclosure.

FIG. 15 is a schematic diagram of a hardware structure of an electronic device according to an embodiment of the disclosure.

### DETAILED DESCRIPTION

The resistor generally adopts a two-terminal structure. Two terminals need to be connected by using a contact hole structure and a metal lead, so as to effectively connect the resistor in other circuits. During current resistance tests, since parasitic resistance is formed due to the existing contact hole structure and the metal lead, and resistance values are also affected by an ambient temperature, an accurate simulation model cannot be established, thereby affecting the simulation accuracy of a subsequent circuit.

According to the method and apparatus for device simulation provided in the embodiments of the disclosure, the resistor of the to-be-detected device is divided into the bulk resistor and the parasitic resistor, and the parasitic resistor is split into the terminal resistor and the contact resistor. The resistance values of the bulk resistor, the terminal resistor, and the contact resistor are analyzed and calculated according to test results. In addition, after the temperature coefficients of resistance corresponding to the bulk resistor, the terminal resistor, and the contact resistor are calculated, calculation results are added to the simulation model. In this way, the simulation model of the to-be-detected device may be accurately established, and the simulation accuracy of the to-be-detected device may be effectively improved.

In order to make objectives, technical solutions, and advantages of embodiments of the present invention clearer, the technical solutions in the embodiments of the present invention will be clearly and completely described below in combination with the drawings in the embodiments of the present invention. It is apparent that the described embodiments are only part of the embodiments of the present invention, not all the embodiments. Based on the embodiments in the present disclosure, all other embodiments obtained by those ordinary skilled in the art without creative work shall fall within the protection scope of the present disclosure. In addition, although the content in the disclosure is introduced according to one or several demonstrative examples, it is to be understood that each aspect of the disclosure can also individually constitute a complete implementation mode.

It is to be noted that, the brief description of the terms in the disclosure is only for the convenience of understanding the implementation modes described next, and is not intended to limit the implementation modes of the disclosure. Unless otherwise stated, these terms should be understood according to their ordinary and usual meanings.

The terms “first”, “second”, and the like in the specification and claims of the disclosure and in the above drawings are used to distinguish similar or like objects or entities and unnecessarily for limiting a specific sequence or sequential order, unless otherwise noted. It is to be understood that such terms may be interchangeable where appropriate, and can be, for example, implemented in a sequence in addition to those illustrated or described in the embodiments of the disclosure.

Furthermore, the terms “include” and “having”, as well as any variations thereof, are intended to cover a non-exclusive inclusion, for example, a product, or a device that includes a series of components is not necessarily limited to those expressly listed components, but may include other components not expressly listed or inherent to such product, or device.

The term “module” as used in the disclosure refers to any known or later developed hardware, software, firmware, artificial intelligence, fuzzy logic or combination of hardware or/and software code and can perform a function associated with the element.

With the development of science and technology, circuit optimization design has become an important stage in the integrated circuit design process. Circuit optimization is intended to enhance the electrical properties of a circuit. The final actual electrical property of the circuit depends not only on device parameter values of the circuit, but also on a parasitic effect of the device, a parasitic effect between the devices, a parasitic effect of wiring, a parasitic effect between the wirings, and a parasitic effect of the wiring and the device, and among the above, the parasitic effect between the adjacent wirings is particularly critical. In terms of a circuit optimization theory, in order to obtain an accurate circuit optimization result, the parasitic effect between device wirings on the designed circuit is required to be accurately considered, including parasitic resistance between the wirings.

As one of the most basic components in a semiconductor integrated circuit, there are many types of resistors, for example, silicide resistors such as an N+ POLY silicide resistor, a P+ POLY silicide resistor, an N+ diffusion silicide resistor, and a P+ diffusion silicide resistor, and unsilicide resistors such as an N+ POLY unsilicide resistor, a P+ POLY unsilicide resistor, an N+ diffusion unsilicide resistor, and a P+ diffusion unsilicide resistor, where N+/P+ represents a doped ion type of the resistor. If it is an N+ type, the doped ion type is an N type, such as phosphorus atoms and arsenic atoms; and if it is a P+ type, the doped ion type is a P type, such as boron atoms and gallium atoms.

In order to predict the performance and reliability of the resistors in an environment where the resistors are located, modeling simulation needs to be performed on the resistor. That is to say, for various components supported by a circuit simulation program, a corresponding electrical model is required to describe the electrical property of a to-be-detected device.

In a modeling simulation technology, in a corresponding software program, data of these resistors are generally separately extracted based on test data of a semiconductor integrated circuit, to establish corresponding resistor simulation models, and there is no connection between the simulation models. By entering names of the corresponding simulation models, the performance of the resistors in various environment parameters may be simulated subsequently.

Optionally, the above soft program may adopt a Simulation Program with Integrated Circuit Emphasis (SPICE). The SPICE is a kind of language and simulator software for circuit description and simulation, and may be configured to detect circuit connection and function integrity and predict circuit behavior. In an SPICE model, a macromodel is usually used for fitting resistance, and customized parameters may be freely added to fit various properties of the resistance by using the macromodel.

In some embodiments, the resistor is generally a two-terminal structure. Two terminals are connected to each other by using a contact hole structure and a metal lead, so as to effectively connect the resistor in other circuits.

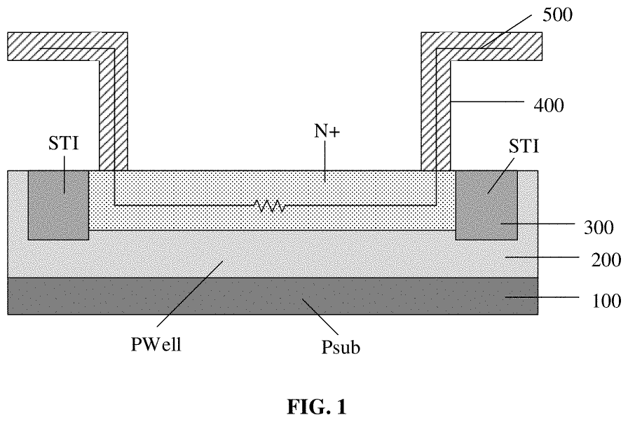

In order to better understand this embodiment of the disclosure, in this embodiment of the disclosure, an N+ diffusion resistor is used as an example. Referring to FIG. 1, FIG. 1 is a schematic diagram I of a longitudinal section of a to-be-detected device according to an embodiment of the disclosure. In FIG. 1, a structure of the above resistor includes a P-substrate 100 (Psub), a P-well structure 200 (PWell), a Shallow Trench Isolation 300 (STI), an N+ injection region, and a plurality of contact plugs 400 and metal leads 500 located on two terminals.

The contact plugs 400 are located above the N+ injection region, and respectively form ohmic contact with the N+ injection region.

In a convention resistor simulation technology, whether it is a silicide resistor or an unsilicide resistor, the extracted simulation model generally mainly includes a bulk resistor (or referred to as a pure resistor).

In some implementations, when the above resistor is used as the to-be-detected device, and when a square resistance value Rs_ndiff of the resistor is determined, the following manner is usually used for determination.

Rs_ndiff=R_total/(L/W)

R_total represents a resistance value of the to-be-detected device, L represents a length of the to-be-detected device on a layout, and W represents a width of the to-be-detected device on the layout.

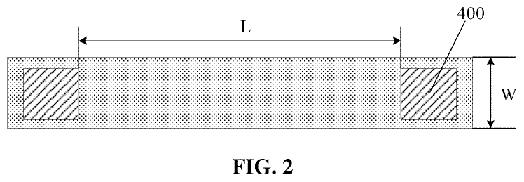

In order to better understand this embodiment, in this embodiment, the N+ diffusion resistor is still used as the example. Referring to FIG. 2, FIG. 2 is a schematic layout diagram I of a to-be-detected device according to an embodiment of the disclosure. In FIG. 2, L represents the length of the to-be-detected device on the layout. W represents the width of the to-be-detected device on the layout. L and W have a same unit, which generally is “μm”. 400 is the contact plugs located on two terminals.

However, the accuracy of circuit simulation not only depends on a device model, but also directly depends on whether the accuracy of a given model parameter value can correctly reflect the electrical properties of the components. Parasitic resistance is formed due to the existing contact plugs and the metal leads in the resistor structure, and the parasitic resistance cannot be deducted during measurement. In addition, an ambient temperature also affects the resistance value of the resistor. As a result, if the parasitic resistance and the impact of the ambient temperature on the resistance value of the resistor cannot be accurately added during the establishment of the simulation model, simulation accuracy is reduced.

Facing the above technical problems, an embodiment of the disclosure provides a method for device simulation. The resistor of the to-be-detected device is divided into a bulk resistor and a parasitic resistor, and the parasitic resistor is split into a terminal resistor and a contact resistor. The resistance values of the bulk resistor, the terminal resistor, and the contact resistor are analyzed and calculated according to test results, along with the temperature coefficients of resistance corresponding to the bulk resistor, the terminal resistor, and the contact resistor. In this way, the simulation model of the to-be-detected device is established. Therefore, the simulation accuracy of the to-be-detected device may be effectively improved. For a specific implementation, refer to the description of the following embodiments.

The method for device simulation provided in an embodiment of the disclosure is applicable to various types of simulation devices, such as a computer, an industrial testing machine, and a mobile terminal. This embodiment of the disclosure is not limited thereto.

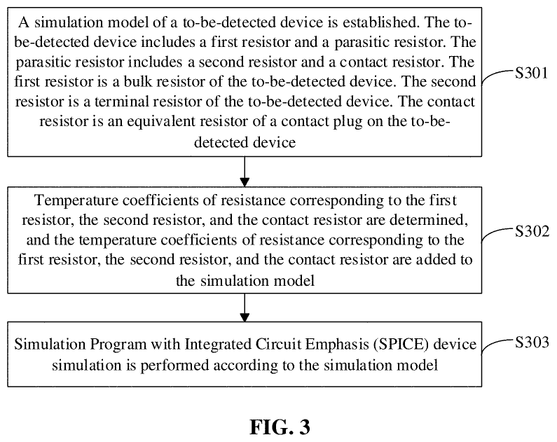

Referring to FIG. 3, FIG. 3 is a schematic flowchart of a method for device simulation according to an embodiment of the disclosure. In a feasible implementation, the method includes the following steps.

At S301, a simulation model of a to-be-detected device is established. The to-be-detected device includes a first resistor and a parasitic resistor. The parasitic resistor includes a second resistor and a contact resistor. The first resistor is a bulk resistor of the to-be-detected device. The second resistor is a terminal resistor of the to-be-detected device. The contact resistor is an equivalent resistor of a contact plug on the to-be-detected device.

In some embodiments, the to-be-detected device may be a resistor.

Optionally, the resistor may be a silicide resistor such as an N+ POLY silicide resistor, a P+ POLY silicide resistor, an N+ diffusion silicide resistor, and a P+ diffusion silicide resistor, or may be an unsilicide resistor such as an N+ POLY unsilicide resistor, a P+ POLY unsilicide resistor, an N+ diffusion unsilicide resistor, and a P+ diffusion unsilicide resistor.

In addition, the resistor may also be a thermistor, a photosensitive resistor, or a varistor, which is not limited in this embodiment of the disclosure.

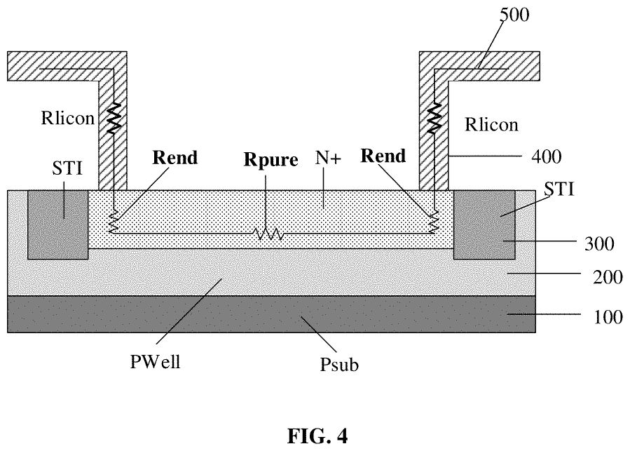

In order to better understand this embodiment of the disclosure, in this embodiment of the disclosure, an N+ diffusion resistor is used as an example. Referring to FIG. 4, FIG. 4 is a schematic diagram II of a longitudinal section of a to-be-detected device according to an embodiment of the disclosure. In FIG. 4, the to-be-detected device includes a P-substrate 100 (Psub), a P-well structure 200 (PWell), a Shallow Trench Isolation 300 (STI), an N+ injection region, and a plurality of contact plugs 400 and metal leads 500 located on two terminals.

The contact plugs 400 are located above the N+ injection region, and respectively form ohmic contact with the N+ injection region.

In this embodiment, a constant terminal resistance and contact resistance are respectively generated at contact terminal portions on two terminals of the resistor that are formed by connecting the contact plugs and the metal leads.

In this embodiment, a simulation model of the resistor may be established based on a working principle of the resistor. By starting from a physical equation of the resistor, the simulation model and model parameters are obtained.

In a feasible implementation, the resistor of the to-be-detected device is divided into a first resistor Rpure (or referred to as the bulk resistor) and a parasitic resistor. Meanwhile, the parasitic resistor is split into a second resistor Rend and a contact resistor Rlicon.

The bulk resistor may be understood as a ratio of a Direct Current (DC) voltage between two contact terminals of the resistor to a through current, and has a unit being ohm.

The second resistor Rend is a terminal resistor of the to-be-detected device. The contact resistor Rlicon is an equivalent resistor of the contact plug 400 on the to-be-detected device.

It may be understood that, since the resistor is generally in a passive symmetrical structure, two second resistors Rend have a same resistance value. Two contact resistors Rlicon also have a same resistance value.

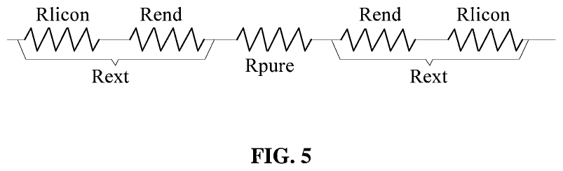

In order to better understand this embodiment, referring to FIG. 5, FIG. 5 is a schematic diagram of an equivalent resistor of a to-be-detected device according to an embodiment of the disclosure. In FIG. 5, the equivalent resistor of the to-be-detected device includes the first resistor Rpure and the parasitic resistor Rext, that is, Rtotal=Rpure+2*Rext. The parasitic resistors Rext may be split into the contact resistors Rlicon and the second resistors Rend, that is:

Rext=Rend+Rlicon=Rend+Rlicon′/N

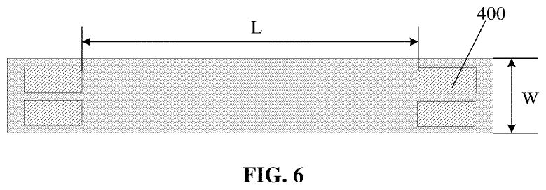

N represents the number of the contact plugs on one contact terminal of the to-be-detected device, and N is an integer greater than or equal to 1. As shown in FIG. 6, FIG. 6 is a schematic layout diagram II of a to-be-detected device according to an embodiment of the disclosure. When there are two contact plugs on the contact terminal of the to-be-detected device, it is equivalent to two contact resistors in parallel, so that the contact resistors become smaller, and the equivalent resistor equals Rlicon′/N.

In this embodiment, after the simulation model is determined, resistance values of the contact resistors Rlicon and the second resistors Rend are respectively calculated by using a preset calculation manner, and are added to the simulation model of the to-be-detected device.

At S302, temperature coefficients of resistance corresponding to the first resistor, the second resistor, and the contact resistor are determined, and the temperature coefficients of resistance corresponding to the first resistor, the second resistor, and the contact resistor are added to the simulation model.

A resistance value of a metal has a linear relationship with a temperature of the metal within a range near normal temperature, so that a relationship between the resistance value of the metal and the temperature of the metal may be represented by using the temperature coefficient of resistance.

In this embodiment, assuming that, at a current to-be-detected ambient temperature, the determined temperature coefficient of resistance of the first resistor Rpure is TC_Rpure, the temperature coefficients of resistance of the second resistors Rend are TC_Rend, and the temperature coefficients of resistance of the contact resistors Rlicon are TC_Rlicon, the equivalent resistor Rtotal of the to-be-detected device may be expressed as:

Rtotal=Rpure*TC_Rpure+2*(Rend*TC_Rend+Rlicon*TC_Rlicon)

At S303, SPICE device simulation is performed according to the simulation model.

In this embodiment of the disclosure, after the simulation model of the to-be-detected device is established and various parameters in the simulation model are determined, SPICE device simulation is performed based on the simulation model, to obtain a simulation result of the to-be-detected device.

Optionally, the calculated resistance values of the first resistor Rpure, the contact resistors Rlicon, and the second resistors Rend, and the calculated temperature coefficients of resistance corresponding to the first resistor Rpure, the contact resistors Rlicon, and the second resistors Rend may be added into a sub circuit model in an SPICE model for simulation. When resistance values of the to-be-detected devices with different sizes are simulated, the simulation model obtains the resistance value of the to-be-detected device with the corresponding size by calculating Rpure, Rend and Rlicon, so that errors in the simulation result can be reduced.

In the SPICE model, a macromodel is usually used for fitting resistance, and customized parameters may be freely added to fit various properties of the resistance by using the macromodel, for example, the properties of the resistor at different temperatures and operating voltages.

Exemplarily, nonlinear direct current analysis, nonlinear transient analysis, and linear alternating current analysis may be performed on a circuit. Simulation content is not limited in this embodiment of the disclosure.

According to the method for device simulation provided in this embodiment of the disclosure, the resistor of the to-be-detected device is divided into the bulk resistor and the parasitic resistor, and the parasitic resistor is split into the terminal resistor and the contact resistor. The resistance values of the bulk resistor, the terminal resistor, and the contact resistor are analyzed and calculated according to test results, along with the temperature coefficients of resistance corresponding to the bulk resistor, the terminal resistor, and the contact resistor. In this way, the simulation model of the to-be-detected device may be accurately established. Therefore, the simulation accuracy of the to-be-detected device may be effectively improved.

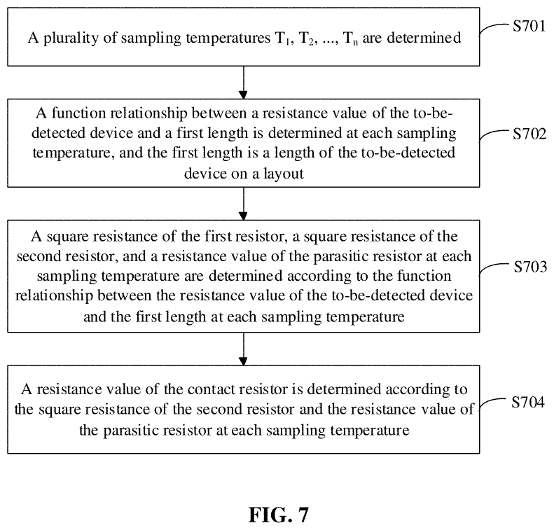

Based on the described content in the above embodiments, referring to FIG. 7, FIG. 7 is a schematic sub-flowchart of a method for device simulation according to an embodiment of the disclosure. In some embodiments, when the simulation model of the to-be-detected device is established, the following steps are included.

At S701, a plurality of sampling temperatures T₁, T₂, . . . , Tₙ are determined.

In this embodiment of the disclosure, a plurality of temperature values may be randomly selected as the sampling temperatures within a commonly used test temperature range.

Exemplarily, in some embodiments, 25° C., 50° C., or 98° C. may be respectively selected as the sampling temperatures T₁, T₂, or T3.

At S702, a function relationship between a resistance value of the to-be-detected device and a first length is determined at each sampling temperature, and the first length is a length of the to-be-detected device on a layout.

In this embodiment of the disclosure, the resistance value Rtotal of the to-be-detected device is a sum of the resistance value of the first resistor Rpure and the resistance values of the parasitic resistors Rext, that is:

Rtotal=Rpure+2Rext

The resistance value of the first resistor Rpure may be determined by means of the following manner.

Rpure=Rs_pure*(L/W)

Rs_pure represents a square resistance of the first resistor Rpure, W is the width of the to-be-detected device on the layout, and L is the length of the to-be-detected device on the layout.

The square resistance may also be referred as a film resistance, and is a resistance represented by a square semiconductor thin layer in a current direction with a unit being ohm/square (ohm/sq).

In a feasible implementation, a relationship between the resistance value Rtotal of the to-be-detected device and the first length L may be expressed by using a function expression, that is:

Rtotal=Rs_pure*(L/W)+2Rext

From the above function expression, it may be learned that the resistance value Rtotal of the to-be-detected device is related to the width W and the length L of the to-be-detected device on the layout, and the resistance value of the parasitic resistor Rext is not related to the width W and the length L of the to-be-detected device on the layout.

In the embodiment of the disclosure, at the sampling temperature Tᵢ, a function relationship between the resistance value Rtotal(Tᵢ) of the to-be-detected device and the first length L may be determined as the following.

Rtotal(Tᵢ)=Rs_pure(Tᵢ)*(L/W)+2Rext

Tᵢ∈(Tᵢ, T₂, . . . , Tₙ), and Rs_pure(Tᵢ) represents the square resistance of the first resistor Rpure at the sampling temperature Tᵢ.

At S703, a square resistance of the first resistor, a square resistance of the second resistor, and a resistance value of the parasitic resistor at each sampling temperature are determined according to the function relationship between the resistance value of the to-be-detected device and the first length at each sampling temperature.

In a feasible implementation, the resistance values of the to-be-detected device corresponding to the same width W and different first lengths L may be respectively measured at each sampling temperature. Then, according to a plurality of measurement results, the square resistance of the first resistor and the resistance value of the parasitic resistor at each sampling temperature are calculated.

For example, in a feasible implementation, a test ambient temperature may first be adjusted to the sampling temperature T₁. Then, the resistance value of the to-be-detected device is detected when the to-be-detected device is at the corresponding same width W and different first lengths L, and the square resistance Rs_pure(T₁) of the first resistor and the resistance value Rext(T₁) of the parasitic resistor at the sampling temperature T₁ are calculated according to the plurality of measurement results. Next, the test ambient temperature is adjusted to the sampling temperature T₂, then the resistance value of the to-be-detected device is detected when the to-be-detected device is at the corresponding same width W and different first lengths L, and the square resistance Rs_pure(T₂) of the first resistor and the resistance value Rext(T₂) of the parasitic resistor at the sampling temperature T₂ are calculated according to the plurality of measurement results, and so on, the square resistance of the first resistor and the parasitic resistor at each sampling temperature may be determined.

Since the contact terminal of the to-be-detected device is in contact with two terminals of the first resistor Rpure, the square semiconductor thin layers represented in the current direction are in a same structure, so that the square resistance Rs_pure(Tᵢ) of the first resistor Rpure at the sampling temperature Tᵢ may be determined as the square resistance Rs_end(Tᵢ) of the second resistor Rend at the sampling temperature Tᵢ.

At S704, a resistance value of the contact resistor is determined according to the square resistance of the second resistor and the resistance value of the parasitic resistor at each sampling temperature.

In a feasible implementation, after the square resistance of the second resistor Rend at each sampling temperature is determined, the resistance value of the second resistor at each sampling temperature may be calculated according to the square resistance of the second resistor at each sampling temperature, the length of the contact terminal of the to-be-detected device on the layout, and the width of the to-be-detected device on the layout.

Since, in this embodiment, the parasitic resistor Rext is split into the second resistor Rend and the contact resistor Rlicon, the resistance value of the contact resistor Rlicon at each sampling temperature may be calculated according to the resistance values of the parasitic resistor Rext and the second resistor Rend at each sampling temperature after the resistance values of the parasitic resistor Rext and the second resistor Rend at each sampling temperature are determined.

Based on the described content in the above embodiments, in some embodiments, when the function relationship between the resistance value of the to-be-detected device and the first length at each sampling temperature is determined, a function expression between the resistance value Rtotal(Tᵢ) of the to-be-detected device and the first length L at the sampling temperature Tᵢ is first determined as the following.

Rtotal(Tᵢ)=Rs_pure(Tᵢ)*(L/W)+2Rext

Rs_pure(Tᵢ) represents the square resistance of the first resistor Rpure at the sampling temperature Tᵢ, W is the width of the to-be-detected device on the layout, and Rext represents the parasitic resistor.

From the above function expression, it may be learned that, at a same temperature, the resistance value Rtotal of the to-be-detected device is related to the width W and the length L of the to-be-detected device on the layout, and the resistance value of the parasitic resistor Rext is not related to the width W and the length L of the to-be-detected device on the layout.

In a feasible implementation, the resistance value Rtotal(Lₓ) of the to-be-detected device at the corresponding same width W and different lengths Lₓ may be respectively measured at the sampling temperature Tᵢ. Plotting is performed by using the length Lₓ as an X axis and the resistance value Rtotal(Lₓ) as a Y axis, then linear fitting is performed, and a function curve corresponding to the resistance value Rtotal of the to-be-detected device and the first length L in the rectangular coordinate system at the sampling temperature Tᵢ is determined.

Through the function curve, a function relationship between the resistance value Rtotal of the to-be-detected device and the first length L at the sampling temperature Tᵢ may be determined.

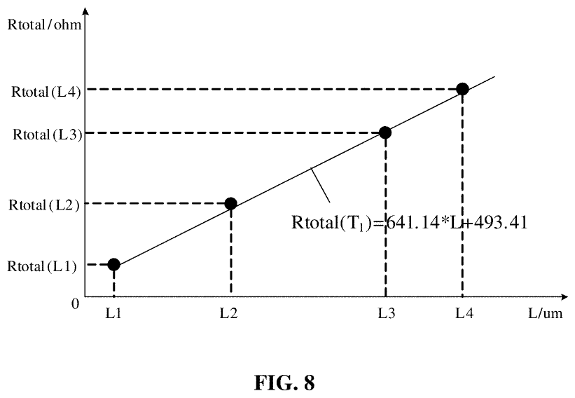

In order to better understand this embodiment of the disclosure, referring to FIG. 8, FIG. 8 is a schematic diagram of a function curve of a resistance value of the to-be-detected device and a first length according to an embodiment of the disclosure.

In a feasible implementation, the width of the to-be-detected device on the layout is fixed as W0, and the length L of the to-be-detected device on the layout is set to L1, L2, L3, or L4, where the values of L1, L2, L3, and L4 are different and increase sequentially.

The test ambient temperature T is maintained as the sampling temperature T₁. Then the resistance values of the to-be-detected device with the width being W0 and the length L being L1, L2, L3, and L4 are measured respectively. In some embodiments, assuming that the measured resistance value of the to-be-detected device when the width is W₀ and the length is L1 is Rtotal(L1), the measured resistance value when the width is W₀ and the length is L2 is Rtotal(L2), the measured resistance value when the width is W₀ and the length is L3 is Rtotal(L3), and the measured resistance value when the width is W₀ and the length is L4 is Rtotal(L4), the rectangular coordinate system is established by using the first length L as the X axis and the resistance value Rtotal as the Y axis. Points are plotted in the rectangular coordinate system according to the resistance value of the to-be-detected device measured by using different lengths, then linear fitting is performed, and the function curve of the resistance value Rtotal of the to-be-detected device and the first length L in the rectangular coordinate system is determined.

The resistance value Rtotal of the resistor and the first length L are used as observed quantities. An optimal estimated value of a parameter Rs_pure(T₁)/W is sought through linear fitting, that is, to seek an optimal theoretical curve Rtotal(T₁)=Rs_pure(T₁)*L/W+2Rext.

As shown in FIG. 8, after linear fitting, Rtotal(T₁)=641.14*L+493.41, and it may be obtained that:

Rs_pure(T₁)/W=641.14; 2Rext=493.41

The above linear fitting method may establish a data relationship (a mathematical model) according to given discrete data points, and obtain a series of Tᵢny straight line segments to connect these interpolation points into a curve, and as long as the interval of the interpolation points is selected properly, a smooth function curve may be formed. The function curve may be expressed by using a function or parameter equation.

Optionally, curve fitting may be performed by using a least square method or by using matlab software. A specific curve fitting manner is not limited in this embodiment of the disclosure.

By using a same manner, the function curve corresponding to the resistance value of the to-be-detected device and the first length in the preset rectangular coordinate system at any sampling temperature may be obtained.

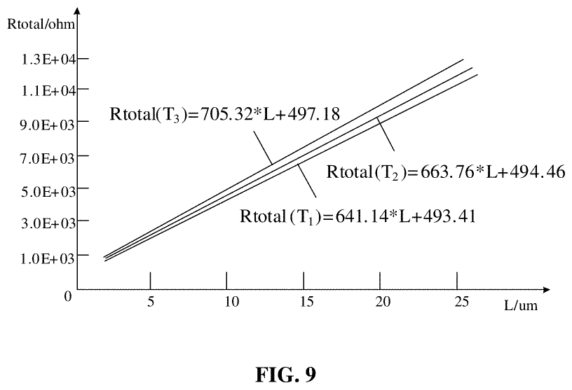

In order to better understand this embodiment of the disclosure, referring to FIG. 9, FIG. 9 is a schematic diagram of a function curve of a resistance value of the to-be-detected device and a first length at different sampling temperatures according to an embodiment of the disclosure.

In a feasible implementation, after the function curve between the resistance value of the to-be-detected device and the first length at each sampling temperature is determined, the square resistance of the first resistor, the square resistance of the second resistor, and the resistance value of the parasitic resistor at each sampling temperature may be determined according to the function relationship.

Exemplarily, the square resistance Rs_pure(Tᵢ) of the first resistor Rpure and the resistance value Rext(Tᵢ) of the parasitic resistor may first determined according to the function relationship between the resistance value Rtotal(Tᵢ) of the to-be-detected device and the first length L at the sampling temperature Tᵢ. Then, the square resistance Rs_end(Tᵢ) of the second resistor is determined according to the square resistance Rs_pure(Tᵢ) of the first resistor Rpure.

Herein, Tᵢ∈(T₁, T₂, . . . , Tₙ).

In a feasible implementation, a slope K(Tᵢ) and an intercept B(Tᵢ) of the function relationship between the resistance value Rtotal(Tᵢ) of the to-be-detected device and the first length L may first be determined. Since the function relationship between the resistance value Rtotal(Tᵢ) of the to-be-detected device and the first length L is:

Rtotal(Tᵢ)=Rs_pure(Tᵢ)*L/W+2Rext(Tᵢ)

it may be obtain that:

K(Tᵢ)=Rs_pure(Tᵢ)/W

B(Tᵢ)=2Rext(Tᵢ)

through further calculation, it may be obtain that:

Rs_pure(Tᵢ)=K(Tᵢ)*W

Rext(Tᵢ)=B(Tᵢ)/2

W is the width of the to-be-detected device on the layout.

Exemplarily, still referring to FIG. 9, at the sampling temperature T₁, curve fitting is performed on the measured resistance values of the plurality of to-be-detected devices with W=0.33 μm, so as to determine the function curve between the resistance value Rtotal(T₁) of the to-be-detected device and the first length L as the following.

Rtotal(T₁)=641.14*L+493.41

Therefore, the slope K(T₁) of the function curve may be determined to be equal to 641.14, and the intercept B(Tᵢ) may be determined to be equal to 493.41.

Through further calculation, it may be obtain that:

Rs_pure(T₁)=K(T₁)*W=641.14*0.33≈211.6(ohm/sq)

Rext(T₁)=B(T₁)/2=493.41/2≈246.7(ohm)

Likewise, according to the sampling temperature T₂, and Rtotal(T₂)=663.76*L+494.46, it may be determined that:

Rs_pure(T₂)=K(T₂)*W=663.76*0.33≈219.0(ohm/sq)

Rext(T₂)=B(T₂)/2=494.46/2≈247.2(ohm)

Likewise, according to the sampling temperature T₃, and Rtotal(T₃)=705.32*L+497.18, it may be determined that:

Rs_pure(T₃)=K(T₃)*W=705.32*0.33≈232.8(ohm/sq)

Rext(T₃)=B(T₃)/2=497.18/2≈248.6(ohm)

In a feasible implementation, since the contact terminal of the to-be-detected device is in contact with two terminals of the first resistor Rpure, the square semiconductor thin layers represented in the current direction are in a same structure, so that the square resistance Rs_pure(Tᵢ) of the first resistor Rpure at the sampling temperature Tᵢ may be determined as the square resistance Rs_end(Tᵢ) of the second resistor Rend at the sampling temperature Tᵢ, that is:

Rs_end(Tᵢ)=Rs_pure(Tᵢ)

In a feasible implementation, after the square resistance Rs_end(Tᵢ) of the second resistor Rend at the sampling temperature Tᵢ is determined, through further calculation, the resistance value of the second resistor Rend at the sampling temperature Tᵢ may be determined as follows.

Rend(Tᵢ)=Rs_end(Tᵢ)*L_end/W

L_end represents the length of the contact terminal of the to-be-detected device on the layout, and W represents the width of the to-be-detected device on the layout.

In a feasible implementation, both the length L_end of the contact terminal of the to-be-detected device on the layout and the second resistor may be used as simulation parameters. Therefore, the length L_end of the contact terminal of the to-be-detected device on the layout may be customized, which is not limited in this embodiment of the disclosure.

In a feasible implementation, the length L_end of the contact terminal of the to-be-detected device on the layout may alternatively be a length between one side of the contact terminal of the to-be-detected device and one side of the to-be-detected device on the layout.

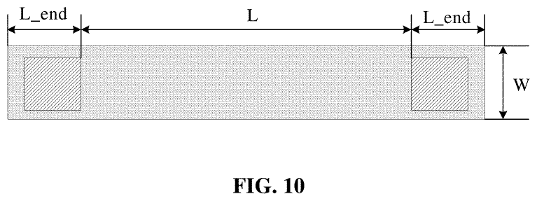

In order to better understand this embodiment, in this embodiment, the N+ diffusion resistor is used as the example. Referring to FIG. 10, FIG. 10 is a schematic length diagram I of a contact terminal of a to-be-detected device on a layout according to an embodiment of the disclosure. In FIG. 10, the length between a side inside the contact terminal of the to-be-detected device and one side of the to-be-detected device outside the layout may be used as the length L_end of the contact terminal of the to-be-detected device on the layout.

In another feasible implementation, the length L_end of the contact terminal of the to-be-detected device on the layout may be a length between two sides of the contact terminal of the to-be-detected device.

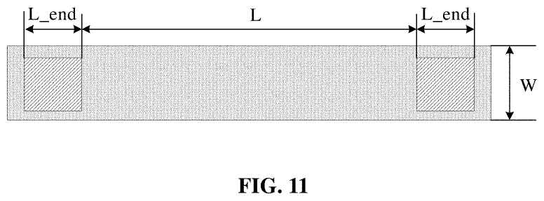

In order to better understand this embodiment of the disclosure, in this embodiment of the disclosure, the N+ diffusion resistor is still used as the example. Referring to FIG. 11, FIG. 11 is a schematic length diagram II of a contact terminal of a to-be-detected device on a layout according to an embodiment of the disclosure. In FIG. 11, the length between a side inside the contact terminal of the to-be-detected device and a side outside the contact terminal of the to-be-detected device may be used as the length L_end of the contact terminal of the to-be-detected device on the layout.

In a feasible implementation, after the resistance of the second resistor Rend and the resistance value of the parasitic resistor Rext at each sampling temperature are determined, the resistance value of the contact resistor Rlicon at each sampling temperature may be calculated according to the resistance of the second resistor Rend and the resistance value of the parasitic resistor Rext at each sampling temperature.

In a feasible implementation, since at the sampling temperature Tᵢ, and Rext(Tᵢ)=Rend(Tᵢ)+Rlicon(Tᵢ), it may be calculated that:

Rlicon(Tᵢ)=Rext(Tᵢ)−Rend(Tᵢ)=Rext(Tᵢ)−Rs_end(Tᵢ)*L_end/W

When the number N of the contact plugs on the contact terminal of the to-be-detected device is greater than or equal to 2, the resistance value of the single contact plug at the sampling temperature Tᵢ is as follows.

Rlicon′(Tᵢ)=Rlicon(Tᵢ)*N

According to the method for device simulation provided in this embodiment of the disclosure, the equivalent resistor of the to-be-detected device is divided into the bulk resistor and the parasitic resistor, and the parasitic resistor is split into the terminal resistor and the contact resistor. When the simulation model of the to-be-detected device is established, according to the function curve between the resistance value of the to-be-detected device and the length of the to-be-detected device on the layout, resistance values of the terminal resistor and the contact resistor may be respectively calculated by using a preset algorithm. During simulation, the resistance values of the terminal resistor and the contact resistor are added into the SPICE model. In this way, errors in the simulation result can be reduced, and the simulation accuracy of the to-be-detected device can be improved.

Based on the described content in the above embodiments, after the square resistance Rs_pure(T₁), Rs_pure(T₂), . . . , Rs_pure(Tₙ) of the first resistor Rpure at each sampling temperature T₁, T₂, . . . , Tₙ is determined, plotting is performed by using a difference between the sampling temperature Tᵢ and a baseline sampling temperature Tⱼ as the X axis and a quotient of the square resistance Rs_pure(Tᵢ) of the first resistor at the sampling temperature Tᵢ and the square resistance Rs_pure(Tⱼ) of the first resistor at the baseline sampling temperature Tⱼ as the Y axis, then linear fitting is performed, and the function curve of the temperature coefficient of resistance TC_Rpure(Tᵢ) of the first resistor Rpure and the sampling temperature Tᵢ is determined.

Herein, Tᵢ, Tⱼ∈(T₁, T₂, . . . , Tₙ).

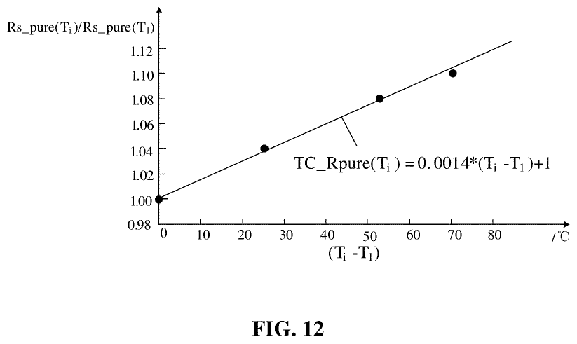

In order to better understand this embodiment of the disclosure, referring to FIG. 12, FIG. 12 is a schematic diagram of a function curve between a temperature coefficient of resistance of a first resistor and an ambient temperature according to an embodiment of the disclosure.

It is assumed that T₁=25° C., T₂=50° C., T₃=80° C., and T₄=98° C.; Rs_pure(T₁)=211.6, Rs_pure(T₂)=219.0, Rs_pure(T₃)=228.9, and Rs_pure(T₄)=232.8; and the baseline sampling temperature Tⱼ=T₁=25° C.

Plotting is performed by using Tᵢ−T₁ as the X axis and Rs_pure(Tᵢ)/Rs_pure(T₁) as the Y axis, then linear fitting is performed, and the function curve of the temperature coefficient of resistance TC_Rpure(Tᵢ) of the first resistor Rpure and the sampling temperature Tᵢ is determined as follows.

TC_Rpure(Tᵢ)=0.0014*(Tᵢ−25)+1

After the function curve of the temperature coefficient of resistance TC_Rpure(Tᵢ) of the first resistor Rpure and the sampling temperature Tᵢ is determined, a function curve of the temperature coefficient of resistance TC_Rpure(t) of the first resistor Rpure and a to-be-detected ambient temperature t may be determined as follows.

TC_Rpure(t)=0.0014*(t−Tⱼ)+1

The temperature coefficient of resistance of the first resistor Rpure at any ambient temperature may be calculated by using the function curve.

In a feasible implementation, since the contact terminal of the to-be-detected device is in contact with two terminals of the first resistor Rpure, the square semiconductor thin layers represented in the current direction are in a same structure, so that the temperature coefficient of resistance of the first resistor Rpure at the ambient temperature t may be determined as the temperature coefficient of resistance of the second resistor Rend at the ambient temperature t, that is:

TC_Rend(t)=TC_Rpure(t)

Based on the described content in the above embodiments, after the resistance Rlicon(T₁), Rlicon(T₂), . . . , Rlicon(Tₙ) of the contact resistor at each of the sampling temperature T₁, T₂, . . . , Tₙ is determined, plotting is performed by using a difference between the sampling temperature Tᵢ and the baseline sampling temperature Tⱼ as the X axis and a quotient of the resistance Rlicon(Tᵢ) of the contact resistor at the sampling temperature Tᵢ and the resistance Rlicon(Tⱼ) of the contact resistor at the baseline sampling temperature Tⱼ as the Y axis, then linear fitting is performed, and the function curve of the temperature coefficient of resistance TC_Rlicon(Tᵢ) of the contact resistor Rlicon and the sampling temperature Tᵢ is determined.

Herein, Tᵢ, Tⱼ∈(T₁, T₂, . . . , Tₙ).

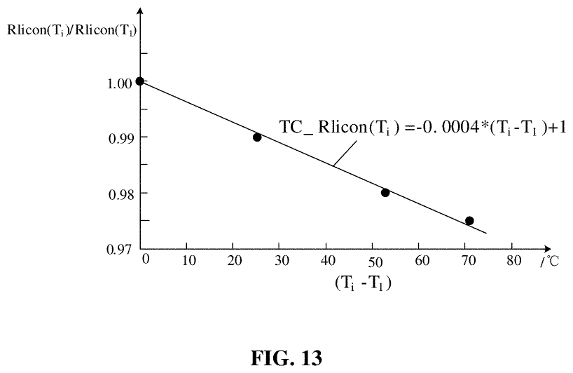

In order to better understand this embodiment of the disclosure, referring to FIG. 13, FIG. 13 is a schematic diagram of a function curve between a temperature coefficient of resistance of a contact resistor and an ambient temperature according to an embodiment of the disclosure.

It is assumed that T₁=25° C., T₂=50° C., T3=80° C., and T4=98° C.; Rlicon(T₁)=182.6, Rlicon(T₂)=180.9, Rlicon(T₃)=178.9, and Rlicon(T₄)=178.1; and the baseline sampling temperature Tⱼ=T₁=25° C.

Plotting is performed by using Tᵢ−T₁ as the X axis and Rlicon(Tᵢ)/Rlicon(T₁) as the Y axis, then linear fitting is performed, and the function curve of the temperature coefficient of resistance TC_Rlicon(Tᵢ) of the contact resistor Rlicon and the sampling temperature Tᵢ is determined as follows.

TC_Rlicon(Tᵢ)=−0.0004*(Tᵢ−25)+1

After the function curve of the temperature coefficient of resistance TC_Rlicon(Tᵢ) of the contact resistor Rlicon and the sampling temperature Tᵢ is determined, a function curve of the temperature coefficient of resistance TC_Rlicon(t) of the contact resistor Rlicon and the to-be-detected ambient temperature t may be determined as follows.

TC_Rlicon(t)=−0.0004*(t−Tⱼ)+1

The temperature coefficient of resistance of the contact resistor Rlicon at any ambient temperature may be calculated by using the function curve.

According to the apparatus for device simulation provided in this embodiment of the disclosure, when the simulation model of the to-be-detected device is established, the resistor of the to-be-detected device is divided into the bulk resistor and the parasitic resistor, and the parasitic resistor is split into the terminal resistor and the contact resistor. The resistance values of the bulk resistor, the terminal resistor, and the contact resistor are analyzed and calculated according to test results, and the temperature coefficients of resistance corresponding to the bulk resistor, the terminal resistor, and the contact resistor are respectively calculated. In this way, the simulation model of the to-be-detected device may be accurately established. Therefore, the simulation accuracy of the to-be-detected device may be effectively improved.

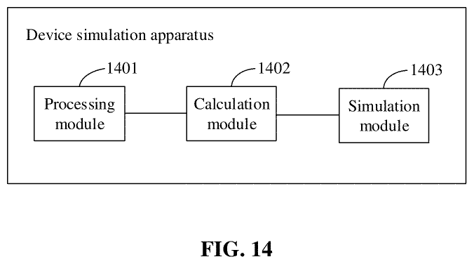

Based on the described content in the above embodiments, an embodiment of the disclosure further provides an apparatus for device simulation. Referring to FIG. 14, FIG. 14 is a schematic diagram of a program module of an apparatus for device simulation according to an embodiment of the disclosure. In a feasible implementation, the apparatus for device simulation includes a processing module, a calculation module, and a simulation module.

The processing module 1401 is configured to establish a simulation model of a to-be-detected device. The to-be-detected device includes a first resistor and a parasitic resistor. The parasitic resistor includes a second resistor and a contact resistor. The first resistor is a bulk resistor of the to-be-detected device. The second resistor is a terminal resistor of the to-be-detected device. The contact resistor is an equivalent resistor of a contact plug on the to-be-detected device.

The calculation module 1402 is configured to determine temperature coefficients of resistance corresponding to the first resistor, the second resistor, and the contact resistor, and add the temperature coefficients of resistance corresponding to the first resistor, the second resistor, and the contact resistor to the simulation model.

The simulation module 1403 is configured to perform device simulation by using SPICE according to the simulation model.

According to the apparatus for device simulation provided in this embodiment of the disclosure, when the simulation model of the to-be-detected device is established, the resistor of the to-be-detected device is divided into the bulk resistor and the parasitic resistor, and the parasitic resistor is split into the terminal resistor and the contact resistor. The resistance values of the bulk resistor, the terminal resistor, and the contact resistor are analyzed and calculated according to test results, and the temperature coefficients of resistance corresponding to the bulk resistor, the terminal resistor, and the contact resistor are respectively calculated. In this way, the simulation model of the to-be-detected device may be accurately established. Therefore, the simulation accuracy of the to-be-detected device may be effectively improved.

In a feasible implementation, the processing module 1401 is specifically configured to perform the following operations.

A plurality of sampling temperatures T₁, T₂, . . . , Tₙ are determined.

A function relationship between a resistance value of the to-be-detected device and a first length is determined at each sampling temperature, and the first length is a length of the to-be-detected device on a layout.

A square resistance of the first resistor, a square resistance of the second resistor, and a resistance value of the parasitic resistor are determined at each sampling temperature according to the function relationship between the resistance value of the to-be-detected device and the first length at each sampling temperature.

A resistance value of the contact resistor is determined at each sampling temperature according to the square resistance of the second resistor and the resistance value of the parasitic resistor at each sampling temperature.

In a feasible implementation, the processing module 1401 is specifically configured to perform the following operations.

At each sampling temperature, the resistance values of the to-be-detected device corresponding to a same width and different first lengths are respectively measured, and the width is a width of the to-be-detected device on the layout.

Plotting is performed by using the first length as an X axis and the resistance value as a Y axis, then linear fitting is performed, and at each sampling temperature, a first function curve corresponding to the resistance value of the to-be-detected device and the first length in a preset rectangular coordinate system is determined.

In a feasible implementation, the processing module 1401 is specifically configured to perform the following operations.

The square resistance of the first resistor is determined at each sampling temperature according to the function relationship between the resistance value of the to-be-detected device and the first length at each sampling temperature.

The resistance value of the parasitic resistor at each sampling temperature is determined according to the function relationship between the resistance value of the to-be-detected device and the first length at each sampling temperature. The resistance value of the parasitic resistor is not related to the first length.

The square resistance of the second resistor is determined at each sampling temperature according to the square resistance of the first resistor at each sampling temperature.

In a feasible implementation, the processing module 1401 is specifically configured to perform the following operation.

The square resistance Rs_pure(Tᵢ) of the first resistor at the sampling temperature Tᵢ is calculated according to a slope K(Tᵢ) of a function curve L(Tᵢ) corresponding to the resistance value of the to-be-detected device and the first length in the preset rectangular coordinate system at the sampling temperature Tᵢ:

Rs_pure(Tᵢ)=K(Tᵢ)*W

W represents the width of the to-be-detected device on the layout, and Tᵢ∈(T₁, T₂, . . . , Tₙ).

In a feasible implementation, the processing module 1401 is specifically configured to perform the following operation.

The resistance value Rext(Tᵢ) of the parasitic resistor at the sampling temperature Tᵢ is calculated according to an intercept B(Tᵢ) of the function curve L(Tᵢ) corresponding to the resistance value of the to-be-detected device and the first length in the preset rectangular coordinate system at the sampling temperature Tᵢ:

Rext(Tᵢ)=B(Tᵢ)/2

Herein, Tᵢ∈(T1, T2, . . . , Tn).

In a feasible implementation, the processing module 1401 is specifically configured to perform the following operation.

The square resistance Rs_pure(Tᵢ) of the first resistor at the sampling temperature Tᵢ is determined as the square resistance Rs_end(Tᵢ) of the second resistor at the sampling temperature Tᵢ.

Herein, Tᵢ∈(T₁, T₂, . . . , Tₙ).

In a feasible implementation, the processing module 1401 is specifically configured to perform the following operation.

The resistance value Rlicon(Tᵢ) of the contact resistor at the sampling temperature Tᵢ is calculated according to the following manner

Rlicon(Tᵢ)=Rext(Tᵢ)−Rs_end(Tᵢ)*L_end/W

Rext(Tᵢ) represents the resistance value of the parasitic resistor at the sampling temperature Tᵢ, Rs_end(Tᵢ) represents the square resistance of the second resistor at the sampling temperature Tᵢ, L_end represents a length of a contact terminal of the to-be-detected device on the layout, and W represents the width of the to-be-detected device on the layout, where Tᵢ∈(T₁, T₂, . . . , Tₙ).

In a feasible implementation, when the number N of the contact plugs on a contact terminal of the to-be-detected device is greater than or equal to 2, a resistance value Rlicon′(Tᵢ) of the single contact plug at the sampling temperature Tᵢ is:

Rlicon′(Tᵢ)=Rlicon(Tᵢ)*N

In a feasible implementation, the calculation module 1402 is specifically configured to perform the following operation.

The temperature coefficient of resistance corresponding to the first resistor is determined according to the following manner.

According to the square resistances Rs_pure(T₁), Rs_pure(T₂), . . . , Rs_pure(Tₙ) of the first resistor at each sampling temperature T₁, T₂, . . . , Tₙ, plotting is performed by using a difference between the sampling temperature Tᵢ and a baseline sampling temperature Tⱼ as an X axis and a quotient of the square resistance Rs_pure(Tᵢ) of the first resistor at the sampling temperature Tᵢ and the square resistance Rs_pure(Tⱼ) of the first resistor at the baseline sampling temperature Tⱼ as a Y axis, then linear fitting is performed, and a second function curve of the temperature coefficient of resistance of the first resistor and an ambient temperature is determined, where Tⱼ∈(T₁, T₂, . . . , Tₙ).

The temperature coefficient of resistance corresponding to the first resistor is determined according to the second function curve and a to-be-detected ambient temperature.

In a feasible implementation, the calculation module 1402 is configured to calculate the temperature coefficient of resistance TC_Rpure(t) corresponding to the first resistor according to the following manner:

TC_Rpure(t)=K₁*(t−Tⱼ)+C₁

K₁ is a slope of the second function curve, t represents the to-be-detected ambient temperature, and C₁ represents an intercept of the second function curve.

In a feasible implementation, the calculation module 1402 is specifically configured to determine the temperature coefficient of resistance corresponding to the contact resistor according to the following manner.

According to the square resistances Rlicon(T₁), Rlicon(T₂), . . . , Rlicon(Tₙ) of the contact resistor at each sampling temperature T₁, T₂, . . . , Tₙ, plotting is performed by using a difference between the sampling temperature Tᵢ and a baseline sampling temperature Tⱼ as an X axis and a quotient of the resistance Rlicon(Tᵢ) of the contact resistor at the sampling temperature Tᵢ and the resistance Rlicon(Tⱼ) of the contact resistor at the baseline sampling temperature Tⱼ as a Y axis, then linear fitting is performed, and a third function curve of the temperature coefficient of resistance of the contact resistor and an ambient temperature is determined, where Tⱼ∈(T₁, T₂, . . . , Tₙ).

The temperature coefficient of resistance corresponding to the contact resistor is determined according to the third function curve and a to-be-detected ambient temperature.

In a feasible implementation, the calculation module 1402 is specifically configured to calculate the temperature coefficient of resistance TC_Rlicon(t) corresponding to the contact resistor according to the following manner

TC_Rlicon(t)=K₂*(t−Tⱼ)+C₂

K₂ is a slope of the third function curve, t represents the to-be-detected ambient temperature, and C₂ represents an intercept of the third function curve.

It is to be noted that, for content that specifically performed by the processing module 1401, the calculation module 1402, and the simulation module 1403 described in the above embodiments, refer to each step in the method for device simulation described in the above embodiments, which are not described herein again.

Further, based on the described content in the above embodiments, an embodiment of the disclosure further provides an electronic device. The electronic device includes at least one processor and a memory. The memory stores a computer-executable instruction. The at least one processor executes the computer-executable instruction stored in the memory to implement each step in the method for device simulation described in the above embodiments. For details, refer to the description in the above embodiments, which are not described herein again.

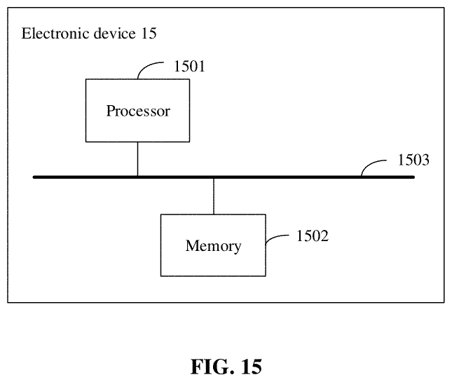

In order to better understand this embodiment of the disclosure, referring to FIG. 15, FIG. 15 is a schematic diagram of a hardware structure of an electronic device according to an embodiment of the disclosure.

As shown in FIG. 15, the electronic device 15 of this embodiment includes the processor 1501 and the memory 1502.

The memory 1502 is configured to store the computer-executable instruction.

The processor 1501 is configured to execute the computer-executable instruction stored in the memory to implement each step in the method for device simulation described in the above embodiments. For details, refer to the description in the above embodiments, which are not described herein again.

Optionally, the memory 1502 may be independent, or may be integrated with the processor 1501.

When the memory 1502 is arranged independently, the device further includes a bus 1503 configured to connect the memory 1502 with the processor 1501.

Further, based on the described content in the above embodiments, an embodiment of the disclosure further provides a computer-readable storage medium. The computer-readable storage medium stores a computer-executable instruction. When the computer-executable instruction is executed by a processor, each step in the method for device simulation described in the above embodiments may be implemented. For details, refer to the description in the above embodiments, which are not described herein again.

Further, based on the described content in the above embodiments, an embodiment of the disclosure further provides a computer program product. The computer program product includes a computer program. When the computer program is executed by a processor, each step in the method for device simulation described in the above embodiments may be implemented. For details, refer to the description in the above embodiments, which are not described herein again.

In several embodiments provided by the disclosure, it is to be understood that the disclosed device and method may be implemented in other ways. For example, the device embodiment described above is only schematic, and for example, division of the modules is only logic function division, and other division manners may be adopted during practical implementation. For example, a plurality of modules may be combined or integrated into another system, or some properties may be neglected or not executed. In addition, the displayed or discussed mutual coupling or direct coupling or communication connection may be indirect coupling or communication connection through some interfaces, apparatuses or modules, and may be in electrical, mechanical or other forms.

The modules described as separate components may or may not be physically separated. The components displayed as modules may or may not be physical units, that is, the components may be located in one place, or may be distributed on the plurality of network units. Part or all of the modules may be selected according to actual requirements to achieve the purposes of the solutions of this embodiment.

In addition, each function module in each embodiment of the disclosure may be integrated into a processing module, or each module may also physically exist independently, or two or more than two modules may also be integrated into a unit. The module integrated unit may be implemented in a hardware form, or may be implemented in form of hardware and software function unit.

The integrated module implemented in form of a software function module may be stored in a computer-readable storage medium. The software function module is stored in a storage medium, including a plurality of instructions configured to enable a computer device (which may be a personal computer, a server, a network device, etc.) or a processor to execute part of the steps of the method in each embodiment of the disclosure.

It should be understood that, the processor may be a central processing unit (CPU), or may also be other general processes, digital signal processors (DSPs), application specific integrated circuits (ASIC), and the like. The general processors may be microprocessors or the processor may also be any conventional processors. In combination with the method provided in the disclosure, the steps may be directly implemented by a hardware processor, or may be performed by a combination of hardware and software modules in the processor.

The memory may include a high-speed Random Access Memory (RAM), or may include a Non-volatile Memory (NVM), for example, at least one disk memory, or may be a USB flash disk, a mobile hard disk, a Read-Only Memory (ROM), a magnetic disk, an optical disk, and the like.

The bus may be an Industry Standard Architecture (ISA) bus, a Peripheral Component (PCI) bus or an Extended Industry Standard Architecture (EISA) bus, and the like. The bus may be divided into an address bus, a data bus, a control bus, and the like. For ease of representation, the bus in the drawings of the disclosure is not limited to only one bus or one type of bus.

The storage medium may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk. The storage medium may be any available media capable of being stored by a general or special computer.

An example storage medium is coupled to a processor, such that the processor can read information from, and write information to, the storage medium. The storage medium can also be a component of the processor. The processor and the storage medium may be located in the ASIC. The processor and the storage medium may also exist in the electronic device or master control device as discrete components.

It can be understood by those of ordinary skill in the art that all or part of the steps of each method embodiment may be completed by instructing related hardware through a program. The program may be stored in a computer-readable storage medium. When the program is executed, operations including the steps of each method embodiment described above are executed. The foregoing storage medium includes: various media capable of storing program codes, such as an ROM, an RAM, a magnetic disk, or an optical disk.

It is to be noted at last: the above various embodiments are only used to illustrate the technical solutions of the disclosure and not used to limit the same. Although the disclosure has been described in detail with reference to the foregoing embodiments, for those of ordinary skill in the art, they can still modify the technical solutions described in the foregoing embodiments, or equivalently replace part or all of the technical features; all these modifications and replacements shall not cause the essence of the corresponding technical solutions to depart from the scope of the technical solutions of the embodiments of the disclosure.

1. A method for device simulation, comprising:
establishing a simulation model of a to-be-detected device, wherein the to-be-detected device comprises a first resistor and a parasitic resistor, the parasitic resistor comprises a second resistor and a contact resistor, the first resistor is a bulk resistor of the to-be-detected device, the second resistor is a terminal resistor of the to-be-detected device, and the contact resistor is an equivalent resistor of a contact plug on the to-be-detected device;
determining temperature coefficients of resistance corresponding to the first resistor, the second resistor, and the contact resistor, and adding the temperature coefficients of resistance corresponding to the first resistor, the second resistor, and the contact resistor to the simulation model; and
performing device simulation by using Simulation Program with Integrated Circuit Emphasis (SPICE) according to the simulation model.

2. The method of claim 1, wherein the establishing a simulation model of a to-be-detected device comprises:
determining a plurality of sampling temperatures T₁, T₂, . . . , Tₙ;
determining a function relationship between a resistance value of the to-be-detected device and a first length at each sampling temperature, wherein the first length is a length of the to-be-detected device on a layout;
determining a square resistance of the first resistor, a square resistance of the second resistor, and a resistance value of the parasitic resistor at each sampling temperature according to the function relationship between the resistance value of the to-be-detected device and the first length at each sampling temperature; and
determining a resistance value of the contact resistor at each sampling temperature according to the square resistance of the second resistor and the resistance value of the parasitic resistor at each sampling temperature.

3. The method of claim 2, wherein the determining a function relationship between a resistance value of the to-be-detected device and a first length at each sampling temperature comprises:
respectively measuring, at each sampling temperature, the resistance values of the to-be-detected device corresponding to a same width and different first lengths, wherein the width is a width of the to-be-detected device on the layout; and
performing plotting by using the first length as an X axis and the resistance value as a Y axis, then performing linear fitting, and determining, at each sampling temperature, a first function curve corresponding to the resistance value of the to-be-detected device and the first length in a preset rectangular coordinate system.

4. The method of claim 3, wherein the determining a square resistance of the first resistor, a square resistance of the second resistor, and a resistance value of the parasitic resistor at each sampling temperature according to the function relationship between the resistance value of the to-be-detected device and the first length at each sampling temperature comprises:
determining the square resistance of the first resistor at each sampling temperature according to the function relationship between the resistance value of the to-be-detected device and the first length at each sampling temperature;
determining the resistance value of the parasitic resistor at each sampling temperature according to the function relationship between the resistance value of the to-be-detected device and the first length at each sampling temperature, wherein the resistance value of the parasitic resistor is not related to the first length; and
determining the square resistance of the second resistor at each sampling temperature according to the square resistance of the first resistor at each sampling temperature.

5. The method of claim 4, wherein the determining the square resistance of the first resistor at each sampling temperature according to the function relationship between the resistance value of the to-be-detected device and the first length at each sampling temperature comprises:
calculating the square resistance Rs_pure(Tᵢ) of the first resistor at the sampling temperature Tᵢ according to a slope K(Tᵢ) of a function curve L(Tᵢ) corresponding to the resistance value of the to-be-detected device and the first length in the preset rectangular coordinate system at the sampling temperature Tᵢ:
Rs_pure(Tᵢ)=K(Tᵢ)*W
wherein W represents the width of the to-be-detected device on the layout, and Tᵢ□(T₁, T₂, . . . , Tₙ).

6. The method of claim 4, wherein the determining the resistance value of the parasitic resistor at each sampling temperature according to the function relationship between the resistance value of the to-be-detected device and the first length at each sampling temperature comprises:
calculating the resistance value Rext(Tᵢ) of the parasitic resistor at the sampling temperature Tᵢ according to an intercept B(Tᵢ) of a function curve L(Tᵢ) corresponding to the resistance value of the to-be-detected device and the first length in the preset rectangular coordinate system at the sampling temperature Tᵢ:
Rext(Tᵢ)=B(Tᵢ)/2
wherein Tᵢ□(T₁, T₂, . . . , Tₙ).

7. The method of claim 4, wherein the determining the square resistance of the second resistor at each sampling temperature according to the square resistance of the first resistor at each sampling temperature comprises:
determining the square resistance Rs_pure(Tᵢ) of the first resistor at the sampling temperature Tᵢ as the square resistance Rs_end(Tᵢ) of the second resistor at the sampling temperature Tᵢ,
wherein Tᵢ□(T₁, T₂, . . . , Tₙ).

8. The method of claim 2, wherein the determining a resistance value of the contact resistor at each sampling temperature according to the square resistance of the second resistor and the resistance value of the parasitic resistor at each sampling temperature comprises:
calculating the resistance value Rlicon(Tᵢ) of the contact resistor at the sampling temperature Tᵢ according to the following manner:
Rlicon(Tᵢ)=Rext(Tᵢ)−Rs_end(Tᵢ)*L_end/W
wherein Rext(Tᵢ) represents the resistance value of the parasitic resistor at the sampling temperature Tᵢ, Rs_end(Tᵢ) represents the square resistance of the second resistor at the sampling temperature Tᵢ, L_end represents a length of a contact terminal of the to-be-detected device on the layout, and W represents a width of the to-be-detected device on the layout, wherein Tᵢ□(T₁, T₂, . . . , Tₙ).

9. The method of claim 8, wherein, when the number N of the contact plugs on a contact terminal of the to-be-detected device is greater than or equal to 2, a resistance value Rlicon═(Tᵢ) of the single contact plug at the sampling temperature Tᵢ is:
Rlicon′(Tᵢ)=Rlicon(Tᵢ)*N.

10. The method of claim 8, wherein a temperature coefficient of resistance corresponding to the first resistor is determined according to the following manner
according to the square resistances Rs_pure(T₁), Rs_pure(T₂), . . . , Rs_pure(Tₙ) of the first resistor at each sampling temperature T₁, T₂, . . . , Tₙ, performing plotting by using a difference between the sampling temperature Tᵢ and a baseline sampling temperature Tⱼ as an X axis and a quotient of the square resistance Rs_pure(Tᵢ) of the first resistor at the sampling temperature Tᵢ and the square resistance Rs_pure(Tⱼ) of the first resistor at the baseline sampling temperature Tⱼ as a Y axis, then performing linear fitting, and determining a second function curve of the temperature coefficient of resistance of the first resistor and an ambient temperature, wherein Tⱼ□(T₁, T₂, . . . , Tₙ); and
determining the temperature coefficient of resistance corresponding to the first resistor according to the second function curve and a to-be-detected ambient temperature.

11. The method of claim 10, wherein the determining the temperature coefficient of resistance corresponding to the first resistor according to the second function curve and a to-be-detected ambient temperature comprises:
calculating the temperature coefficient of resistance TC_Rpure(t) corresponding to the first resistor according to the following manner
TC_Rpure(t)=K₁*(t−Tⱼ)+C₁
wherein K₁ is a slope of the second function curve, t represents the to-be-detected ambient temperature, and C₁ represents an intercept of the second function curve.

12. The method of claim 11, wherein the temperature coefficient of resistance corresponding to the first resistor is same as a temperature coefficient of resistance corresponding to the second resistor.

13. The method of claim 8, wherein the temperature coefficient of resistance corresponding to the contact resistor is determined according to the following manner
according to the square resistances Rlicon(T₁), Rlicon(T₂), . . . , Rlicon(Tₙ) of the contact resistor at each sampling temperature T₁, T₂, . . . , Tₙ, performing plotting by using a difference between the sampling temperature Tᵢ and a baseline sampling temperature Tⱼ as an X axis and a quotient of the resistance Rlicon(Tᵢ) of the contact resistor at the sampling temperature Tᵢ and the resistance Rlicon(Tⱼ) of the contact resistor at the baseline sampling temperature Tⱼ as a Y axis, then performing linear fitting, and determining a third function curve of the temperature coefficient of resistance of the contact resistor and an ambient temperature, wherein Tⱼ□(T₁, T₂, . . . , Tₙ); and
determining the temperature coefficient of resistance corresponding to the contact resistor according to the third function curve and a to-be-detected ambient temperature.

14. The method of claim 13, wherein the determining the temperature coefficient of resistance corresponding to the contact resistor according to the third function curve and a to-be-detected ambient temperature comprises:
calculating the temperature coefficient of resistance TC_Rlicon(t) corresponding to the contact resistor according to the following manner
TC_Rlicon(t)=K₂*(t−Tⱼ)+C₂
wherein K₂ is a slope of the third function curve, t represents the to-be-detected ambient temperature, and C₂ represents an intercept of the third function curve.

15. An electronic device, comprising at least one processor and a memory, wherein
the memory stores computer-executable instructions; and
when the computer-executable instructions stored in the memory are executed by the at least one processor, the at least one processor is configured to:
establish a simulation model of a to-be-detected device, wherein the to-be-detected device comprises a first resistor and a parasitic resistor, the parasitic resistor comprises a second resistor and a contact resistor, the first resistor is a bulk resistor of the to-be-detected device, the second resistor is a terminal resistor of the to-be-detected device, and the contact resistor is an equivalent resistor of a contact plug on the to-be-detected device;
determine temperature coefficients of resistance corresponding to the first resistor, the second resistor, and the contact resistor, and add the temperature coefficients of resistance corresponding to the first resistor, the second resistor, and the contact resistor to the simulation model; and
perform device simulation by using Simulation Program with Integrated Circuit Emphasis (SPICE) according to the simulation model.

16. The electronic device of claim 15, wherein the at least one processor is specifically configured to:
determine a plurality of sampling temperatures T₁, T₂, . . . , Tₙ;
determine a function relationship between a resistance value of the to-be-detected device and a first length at each sampling temperature, wherein the first length is a length of the to-be-detected device on a layout;
determine a square resistance of the first resistor, a square resistance of the second resistor, and a resistance value of the parasitic resistor at each sampling temperature according to the function relationship between the resistance value of the to-be-detected device and the first length at each sampling temperature; and
determine a resistance value of the contact resistor at each sampling temperature according to the square resistance of the second resistor and the resistance value of the parasitic resistor at each sampling temperature.

17. The electronic device of claim 16, wherein the at least one processor is specifically configured to:
respectively measure, at each sampling temperature, the resistance values of the to-be-detected device corresponding to a same width and different first lengths, wherein the width is a width of the to-be-detected device on the layout; and
perform plotting by using the first length as an X axis and the resistance value as a Y axis, then perform linear fitting, and determine, at each sampling temperature, a first function curve corresponding to the resistance value of the to-be-detected device and the first length in a preset rectangular coordinate system.

18. The electronic device of claim 17, wherein the at least one processor is specifically configured to:
determine the square resistance of the first resistor at each sampling temperature according to the function relationship between the resistance value of the to-be-detected device and the first length at each sampling temperature;
determine the resistance value of the parasitic resistor at each sampling temperature according to the function relationship between the resistance value of the to-be-detected device and the first length at each sampling temperature, wherein the resistance value of the parasitic resistor is not related to the first length; and
determine the square resistance of the second resistor at each sampling temperature according to the square resistance of the first resistor at each sampling temperature.

19. The electronic device of claim 18, wherein the at least one processor is specifically configured to:
calculate the square resistance Rs_pure(Tᵢ) of the first resistor at the sampling temperature Tᵢ according to a slope K(Tᵢ) of a function curve L(Tᵢ) corresponding to the resistance value of the to-be-detected device and the first length in the preset rectangular coordinate system at the sampling temperature Tᵢ:
Rs_pure(Tᵢ)=K(Tᵢ)*W
wherein W represents the width of the to-be-detected device on the layout, and Tᵢ□(T₁, T₂, . . . , Tₙ).

20. A computer-readable storage medium, storing computer-executable instructions therein, and when a processor executes the computer-executable instructions, the following operations are performed:
establishing a simulation model of a to-be-detected device, wherein the to-be-detected device comprises a first resistor and a parasitic resistor, the parasitic resistor comprises a second resistor and a contact resistor, the first resistor is a bulk resistor of the to-be-detected device, the second resistor is a terminal resistor of the to-be-detected device, and the contact resistor is an equivalent resistor of a contact plug on the to-be-detected device;
determining temperature coefficients of resistance corresponding to the first resistor, the second resistor, and the contact resistor, and adding the temperature coefficients of resistance corresponding to the first resistor, the second resistor, and the contact resistor to the simulation model; and
performing device simulation by using Simulation Program with Integrated Circuit Emphasis (SPICE) according to the simulation model.
